(19) United States
(12) Patent Application Publication
(10) Pub. No.: US 2007/0235326 A1
(43) Pub. Date: Oct. 11, 2007

(54) Solar-powered oxyhydrogen generating system

(76) Inventor: Wen-Chang Lin, Kaohsiung Hsien (TW)

Correspondence Address: SEYFARTH SHAW LLP, 131 S. DEARBORN ST., SUITE2400, CHICAGO, IL, 60603-5803, US

(21) Appl. No.: 11/400,994

(22) Filed: Apr. 10, 2006

(51) Int. Cl. C25B 9/00; H02N 6/00

(52) U.S. Cl. 204/278; 136/244

(57) ABSTRACT

A solar-powered oxyhydrogen generating system includes an electric oxyhydrogen generator and a solar-power generator. The electric oxyhydrogen generator includes an electrolysis tank for receiving water, a plurality of electrodes extending into the electrolysis tank so as to be immersed in the water, and a gas outlet in spatial communication with the electrolysis tank. The solar-power generator collects solar energy and converts the solar energy thus collected into electrical energy. The solar-power generator is connected to the electric oxyhydrogen generator for supplying electricity to the electrodes of the electric oxyhydrogen generator so that oxyhydrogen gas is generated in the electrolysis tank by virtue of hydrolysis of the water received in the electrolysis tank. The oxyhydrogen gas flows out of the electrolysis tank via the gas outlet.

### BACKGROUND OF THE INVENTION

1. Field of the Invention

The invention relates to an oxyhydrogen generating system, more particularly to a solar-powered oxyhydrogen generating system.

2. Description of the Related Art

As shown in FIG.1, a conventional oxyhydrogen generating system 1 generates oxyhydrogen gas by passing electric current through water molecules to electrolyze water such that the water molecules are dissociated into oxygen and hydrogen gases. The chemical equation of the electrolysis of water is shown below.

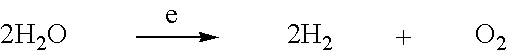

The conventional oxyhydrogen generating system 1 includes an electrolysis tank 11 for receiving electrolyte, i.e., water 110, positive and negative electrodes 12, 13 extending into the electrolysis tank 11 so as to be immersed in the water 110, a rectifier 14 connected electrically to the positive and negative electrodes 12, 13, a pressure regulator 16 coupled to the electrolysis tank 11 for regulating pressure therein, and a gas dryer 17 coupled to the pressure regulator 16.

The conventional oxyhydrogen generating system 1 is connected to a 110V or 220V alternating current (AC) electrical outlet via the rectifier 14. The rectifier 14 converts the AC current into direct current (DC) for subsequent input into the positive and negative electrodes 12, 13. By virtue of hydrolysis of the water 110 received in the electrolysis tank 11, oxygen gas and hydrogen gas are respectively generated in the electrolysis tank 11 at sites of the positive and negative electrodes 12, 13. The oxyhydrogen gas is then outputted as fuel gas for equipments, such as flame cutting machines, after passing through the pressure regulator 16 and the gas dryer 17.

Since oxyhydrogen is odorless, non-toxic and non-polluting, by using oxyhydrogen instead of acetylene as fuel gas to produce high-temperature flames for boilers, soldering and welding tools, steel-cutting, combustion machines, water heaters, etc., advantages of reduced costs and environmental friendliness are achieved.

However, the conventional oxyhydrogen generating system 1 is limited to using commercial AC power (i.e., from conventional power outlets) as its input power. The commercial AC power is mainly produced by nuclear, thermal or natural gas power plants, all of which make use of the limited natural resources of the planet and produce pollution. Thus, it will be beneficial if free energy from the sun, water, or wind is used to generate the power necessary for producing oxyhydrogen.

### SUMMARY OF THE INVENTION

Therefore, the object of the present invention is to provide an oxyhydrogen generating system that uses solar energy as its power supply.

According to one aspect of the present invention, there is provided a solar-powered oxyhydrogen generating system that includes an electric oxyhydrogen generator and a solar-power generator. The electric oxyhydrogen generator includes an electrolysis tank for receiving water, a plurality of electrodes extending into the electrolysis tank so as to be immersed in the water, and a gas outlet in spatial communication with the electrolysis tank. The solar-power generator collects solar energy and converts the solar energy thus collected into electrical energy. The solar-power generator is connected to the electric oxyhydrogen generator for supplying electricity to the electrodes of the electric oxyhydrogen generator so that oxyhydrogen gas is generated in the electrolysis tank by virtue of hydrolysis of the water received in the electrolysis tank. The oxyhydrogen gas flows out of the electrolysis tank via the gas outlet.

According to another aspect of the present invention, there is provided a solar-powered oxyhydrogen generating system that includes an electric oxyhydrogen generator and a solar-power generator. The electric oxyhydrogen generator includes an electrolysis tank for receiving water, a plurality of electrodes extending into the electrolysis tank so as to be immersed in the water, a gas outlet in spatial communication with the electrolysis tank, and a reservoir connected to and in spatial communication with the gas outlet. The solar-power generator includes a solar energy collector for collecting solar energy and for converting the solar energy into electricity, a storage cell unit for storing the electricity generated by the solar energy collector, and a sensor device capable of sensing at least one of intensity of ambient light, residual power in the storage cell unit of the solar-power generator, and pressure in the reservoir of the electric oxyhydrogen generator. The solar-power generator further includes a power controller connected to the electrodes of the electric oxyhydrogen generator, the solar energy collector, the storage cell unit and the sensor device. The power controller is responsive to output of the sensor device for controlling at least one of: storage of the electricity in the storage cell unit; supply of the electricity to the electrodes of the electric oxyhydrogen generator so that oxyhydrogen gas is generated in the electrolysis tank by virtue of hydrolysis of the water received in the electrolysis tank, the oxyhydrogen gas flowing out of the electrolysis tank via the gas outlet into the reservoir; and storage of the oxyhydrogen gas in the reservoir.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional oxyhydrogen generating system;

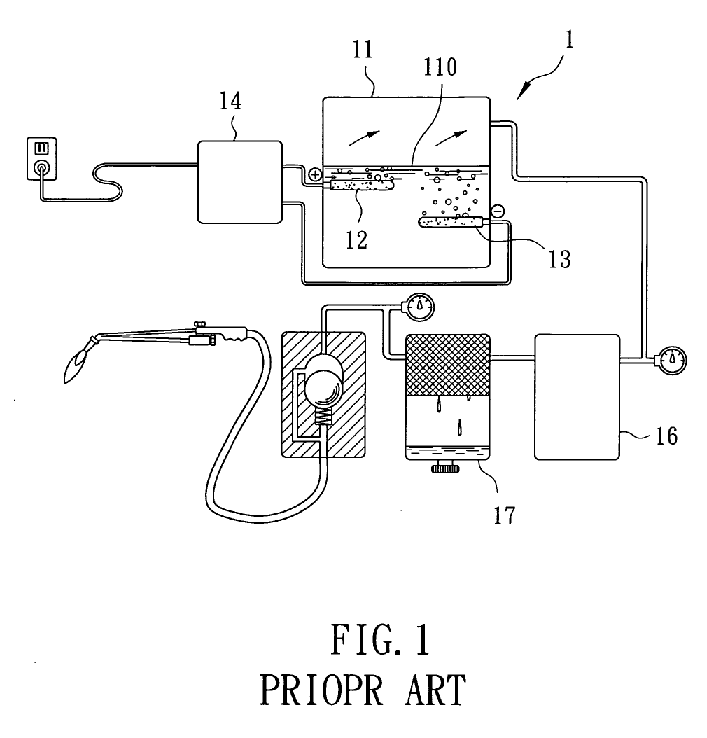

FIG.2 is a schematic view of the preferred embodiment of a solar-powered oxyhydrogen generating system according to the present invention when applied to a flame torch;

FIG.3 is a schematic view of the preferred embodiment when applied to a boiler;

FIG.4 is a schematic view of the preferred embodiment when applied to a combustion machine;

FIG.5 is a schematic view of the preferred embodiment when applied to a water heater; and

FIG.6 is a block diagram of a solar-power generator of the preferred embodiment.

### DETAILED DESCRIPTION OF THE PREFERRED EMBODIMENT

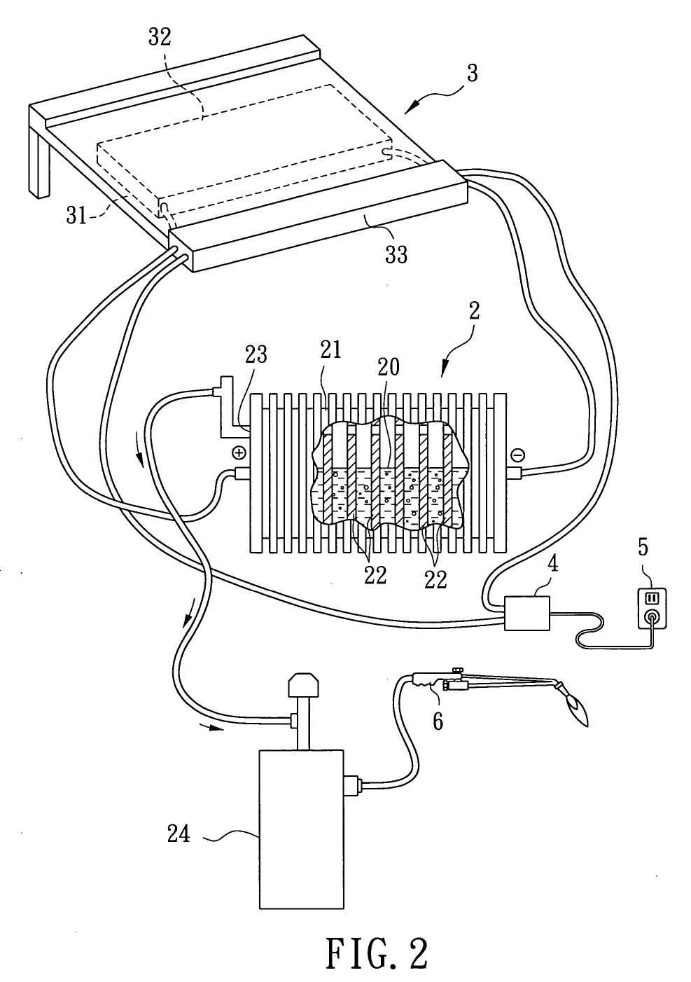

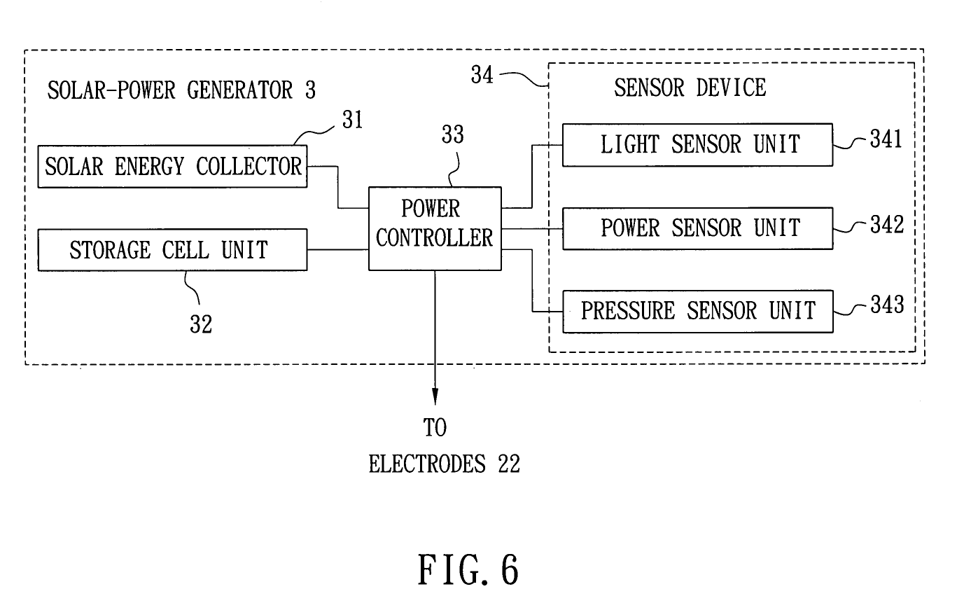

As shown in FIG.2 and FIG.6, the preferred embodiment of a solar-powered oxyhydrogen generating system according to the present invention includes an electric oxyhydrogen generator 2 and a solar-power generator.3.

The electric oxyhydrogen generator 3 includes an electrolysis tank 21 for receiving water 20, a plurality of electrodes 22 extending into the electrolysis tank 21 so as to be immersed in the water 20, a gas outlet 23 in spatial communication with the electrolysis tank 21, and a reservoir 24 connected to and in spatial communication with the gas outlet 23.

In this embodiment, the right most and the left most electrodes 22 are respectively supplied with positive and negative electric charges such that oxyhydrogen gas is generated in the electrolysis tank 21 by virtue of hydrolysis of the water 20 received in the electrolysis tank 21. The oxyhydrogen gas flows out of the electrolysis tank 21 via the gas outlet 23 into the reservoir 24. It should be noted that the electrodes 22 can have various shapes, sizes and numbers, and are not limited to those shown in this embodiment. Since the feature of the present invention does not reside in the electric oxyhydrogen generator 3, further details of the same are omitted herein for the sake of brevity.

The solar-power generator 3 includes a solar energy collector 31, a storage cell unit 32, and a sensor device 34. The solar energy collector 31 is capable of collecting solar energy and converting the solar energy into electricity. The storage cell unit 32 is capable of storing the electricity generated by the solar energy collector 31. The sensor device 34 is capable of sensing at least one of intensity of ambient light, residual power in the storage cell unit 32 of the solar-power generator 3, and pressure in the reservoir 24 of the electric oxyhydrogen generator 2.

In this embodiment, the solar energy collector 31 includes a plurality of photoelectric panels (not shown), each of which is made from a semiconductor material. It should be noted herein that the configuration of the solar energy collector 31 is not limited to the photoelectric panels as illustrated in this embodiment. The solar energy collector 31 can also be composed of thermoelectric cells in other embodiments of the present invention. In addition, the storage cell unit 32 may include a plurality of battery cells, but only one is shown in this embodiment.

In this embodiment, the solar-powered oxyhydrogen generating system is a fully automated system, where the solar-power generator 3 further includes a power controller 33 connected to the solar energy collector 31, the storage cell unit 32, the sensor device 34, and the electrodes 22 of the electric oxyhydrogen generator 2. The power controller 33 is responsive to output of the sensor device 34 for controlling at least one of: storage of the electricity in the storage cell unit 32; supply of the electricity to the electrodes 22 of the electric oxyhydrogen generator 2 so that the oxyhydrogen gas is generated in the electrolysis tank 21 by virtue of hydrolysis of the water 20 received in the electrolysis tank 21; and storage of the oxyhydrogen gas in the reservoir 24.

In this embodiment, the sensor device 34 includes a light sensor unit 341 capable of sensing the intensity of ambient light, a power sensor unit 342 capable of sensing the residual power stored in the storage cell unit 32 of the solar-power generator 3, and a pressure sensor unit 343 capable of sensing the pressure in the reservoir 24 of the electric oxyhydrogen generator 2.

In particular, the power controller 33 controls the supply of the electricity from the solar energy collector 31 to the electrodes 22 of the electric oxyhydrogen generator 2 so as to generate the oxyhydrogen gas when the intensity of ambient light sensed by the light sensor unit 341 is sufficient for causing the solar energy collector 31 to generate adequate electricity to enable the electric oxyhydrogen generator 2 to generate oxyhydrogen gas. The power controller 33 controls the supply of the electricity from the storage cell unit 31 to the electrodes 22 of the electric oxyhydrogen generator 2 so as to generate the oxyhydrogen gas when the amount of the residual power stored in the storage cell unit 32 sensed by the power sensor unit 342 is sufficient for causing the electric oxyhydrogen generator 2 to generate oxyhydrogen gas. The power controller 33 controls the storage of the oxyhydrogen gas in the reservoir 24 when the pressure sensed by the pressure sensor unit 343 is insufficient.

In this embodiment, the power controller 33 mainly controls the supply of the electricity to the electrodes 22 of the electric oxyhydrogen generator 2. Since it is not guaranteed that the intensity of the ambient light is sufficient for the solar energy collector 31 to generate adequate electricity or that the residual power in the storage cell unit 32 is sufficient when oxyhydrogen is needed, the power controller 33 is further connected to a commercial AC power outlet 5 via a rectifier 4.

The operation of the power controller 33 is described hereinbelow with reference to FIG. 2, where the solar-powered oxyhydrogen generating system according to the preferred embodiment is applied to a flame torch 6.

In particular, when the light sensor unit 341 of the sensor device 34 sensed that there is sufficient ambient light for causing the solar energy collector 31 to generate adequate electricity to enable the electric oxyhydrogen generator 2 to generate the oxyhydrogen gas, it is a primary option for the power controller 33 to control the supply of the electricity from the solar energy collector 31 to the electrodes 22 of the electric oxyhydrogen generator 2 so as to generate the oxyhydrogen gas. The power controller 33 can also control the storage of electricity in the electricity generated by the solar energy collector 31 in the storage cell unit 32 at this time.

When insufficient ambient light is sensed by the light sensor unit 341, it is a secondary option of the power controller 33 to control the supply of the electricity from the storage cell unit 32 to the electrodes 22 of the electric oxyhydrogen generator 2 so as to generate the oxyhydrogen gas if there is sufficient residual power therein as sensed by the power sensor unit 342 for causing the electric oxyhydrogen generator 2 to generate the oxyhydrogen gas.

When the sensor device 34 sensed that there is insufficient ambient light and insufficient residual power in the storage cell unit 32 for causing the electric oxyhydrogen generator 2 to generate the oxyhydrogen gas, the power controller 33 operates under its tertiary option, which is to control the supply of the electricity from the commercial AC power outlet 5.

Moreover, when the pressure sensed by the pressure sensor unit 343 of the sensor device 34 is insufficient, the power controller 33 controls the storage of the oxyhydrogen gas in the reservoir 24 of the electric oxyhydrogen generator 2 so as to ensure that there is enough oxyhydrogen gas for the application, i.e., the flame torch 6 in this embodiment, to use whenever it is needed. The oxyhydrogen gas is used by the flame torch 6 to perform high-temperature melting and soldering of welding metals.

It should be noted herein that the order of the primary, secondary and tertiary options for the power controller 33 is pre-set by the designer, and can be implemented using a programmable logic controller (PLC).

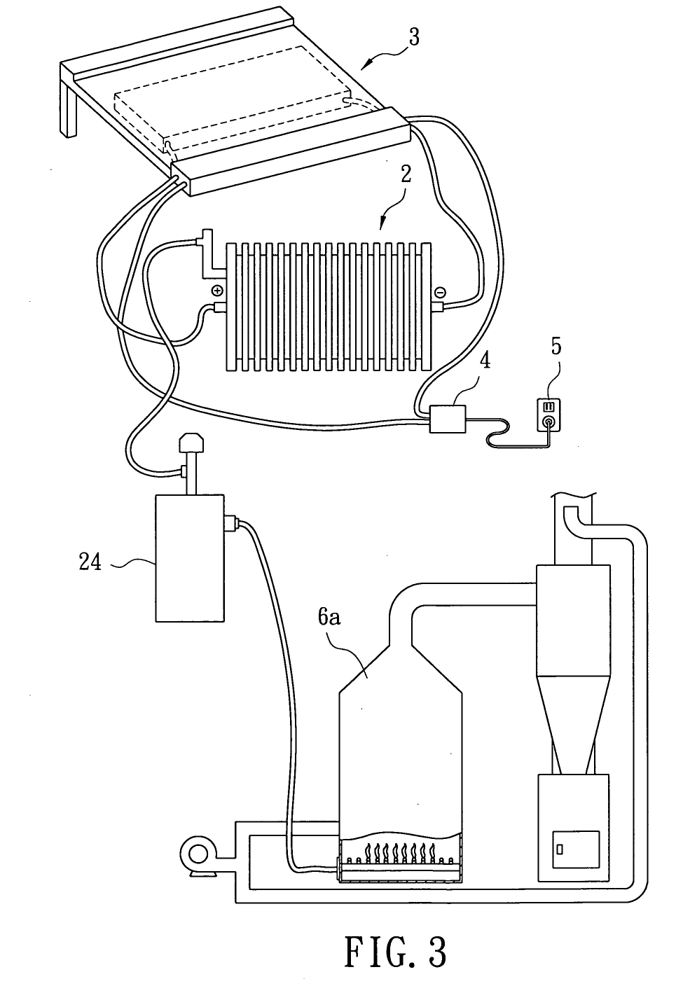

As shown in FIG.3, the solar-powered oxyhydrogen generating system according to the present invention is applied to a boiler 6a, where the oxyhydrogen gas is used to generate high-temperature flames to heat the boiler 6a.

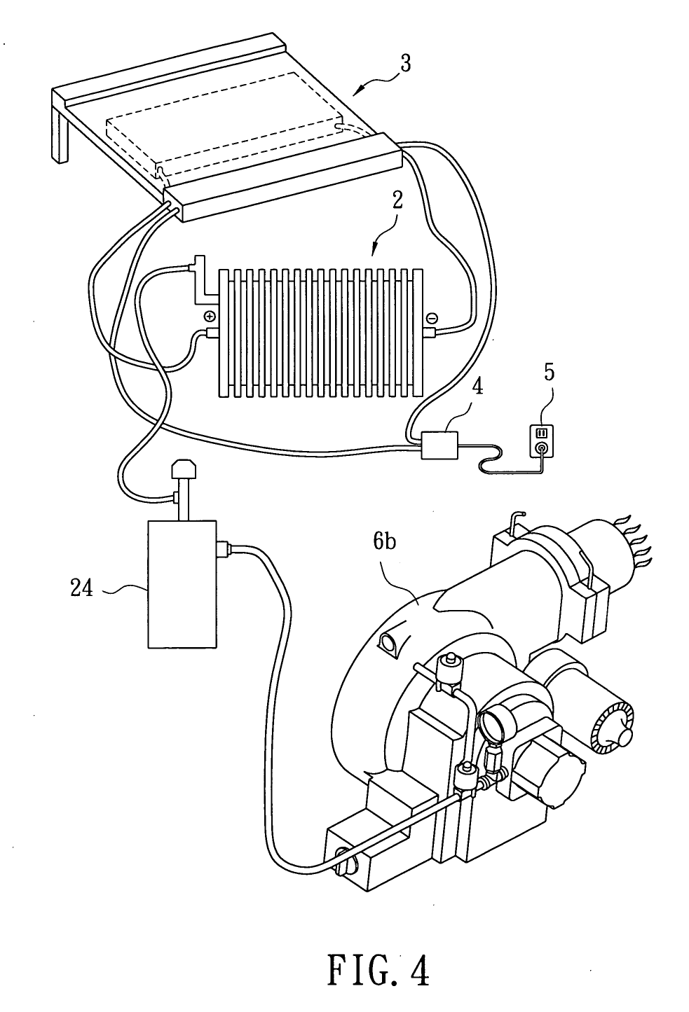

As shown in FIG.4, the solar-powered oxyhydrogen generating system is applied to a combustion machine 6b, where the oxyhydrogen gas is burned to produce high temperature flames.

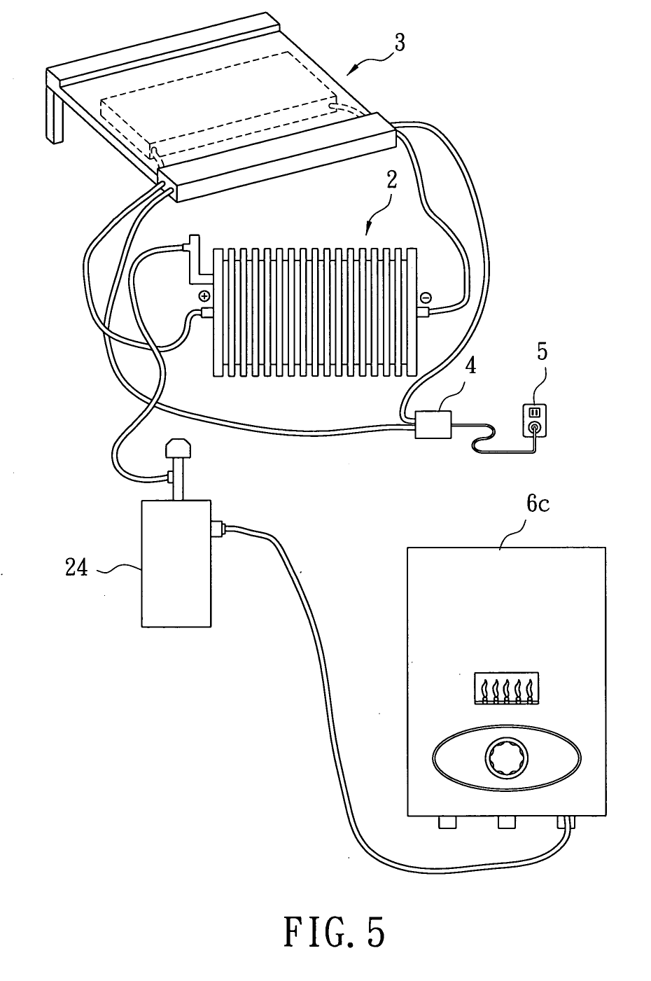

As shown in FIG.5, the solar-powered oxyhydrogen generating system is applied to a water heater 6c, where the oxyhydrogen gas is used as burning fuel to heat up water.

In conclusion, by including a solar-power generator 3, the solar-powered oxyhydrogen generating system according to the present invention can effectively reduce the use of limited natural resources to generate oxyhydrogen.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. A solar-powered oxyhydrogen generating system comprising:
an electric oxyhydrogen generator including an electrolysis tank for receiving water, a plurality of electrodes extending into said electrolysis tank so as to be immersed in the water, and a gas outlet in spatial communication with said electrolysis tank; and
a solar-power generator for collecting solar energy and for converting the solar energy thus collected into electrical energy, said solar-power generator being connected to said electric oxyhydrogen generator for supplying electricity to said electrodes of said electric oxyhydrogen generator so that oxyhydrogen gas is generated in said electrolysis tank by virtue of hydrolysis of the water received in said electrolysis tank, the oxyhydrogen gas flowing out of said electrolysis tank via said gas outlet.

2. The solar-powered oxyhydrogen generating system as claimed in claim 1, wherein said electric oxyhydrogen generator further includes a reservoir connected to and in spatial communication with said gas outlet for storing the oxyhydrogen gas.

3. The solar-powered oxyhydrogen generating system as claimed in claim 1, wherein said solar-power generator includes a solar energy collector for collecting the solar energy and for converting the solar energy into electricity, a storage cell unit for storing the electricity generated by said solar energy collector, and a power controller connected to said electrodes of said electric oxyhydrogen generator, said solar energy collector, and said storage cell unit for controlling storage of the electricity into said storage cell unit and for controlling supply of electricity to said electrodes of said electric oxyhydrogen generator.

4. A solar-powered oxyhydrogen generating system comprising:
an electric oxyhydrogen generator including an electrolysis tank for receiving water, a plurality of electrodes extending into said electrolysis tank so as to be immersed in the water, a gas outlet in spatial communication with said electrolysis tank, and a reservoir connected to and in spatial communication with said gas outlet; and
a solar-power generator including a solar energy collector for collecting solar energy and for converting the solar energy into electricity, a storage cell unit for storing the electricity generated by said solar energy collector, and a sensor device capable of sensing at least one of intensity of ambient light, residual power in said storage cell unit of said solar-power generator, and pressure in said reservoir of said electric oxyhydrogen generator,
said solar-power generator further including a power controller connected to said electrodes of said electric oxyhydrogen generator, said solar energy collector, said storage cell unit, and said sensor device, said power controller being responsive to output of said sensor device for controlling at least one of: storage of the electricity in said storage cell unit; supply of the electricity to said electrodes of said electric oxyhydrogen generator so that oxyhydrogen gas is generated in said electrolysis tank by virtue of hydrolysis of the water received in said electrolysis tank, the oxyhydrogen gas flowing out of said electrolysis tank via said gas outlet into said reservoir; and storage of the oxyhydrogen gas in said reservoir.

5. The solar-powered oxyhydrogen generating system as claimed in claim 4, wherein said sensor device includes a light sensor unit capable of sensing the intensity of ambient light, said power controller controlling the supply of the electricity from said solar energy collector to said electrodes of said electric oxyhydrogen generator so as to generate the oxyhydrogen gas when the intensity of ambient light sensed by said light sensor unit is adequate for causing said solar energy collector to generate sufficient electricity to enable said electric oxyhydrogen generator to generate the oxyhydrogen gas.

6. The solar-powered oxyhydrogen generating system as claimed in claim 4, wherein said sensor device includes a power sensor unit capable of sensing amount of the residual power in said storage cell unit of said solar-power generator, said power controller controlling the supply of the electricity from said storage cell unit to said electrodes of said electric oxyhydrogen generator so as to generate the oxyhydrogen gas when the amount of the residual power sensed by said power sensor unit is sufficient for causing said electric oxyhydrogen generator to generate the oxyhydrogen gas.

7. The solar-powered oxyhydrogen generating system as claimed in claim 4, wherein said sensor device includes a pressure sensor unit capable of sensing the pressure in said reservoir of said electric oxyhydrogen generator, said power controller controlling the storage of the oxyhydrogen gas in said reservoir when the pressure sensed by said pressure sensor unit is insufficient.

8. The solar-powered oxyhydrogen generating system as claimed in claim 4, wherein said sensor device includes a light sensor unit capable of sensing the intensity of ambient light, a power sensor unit capable of sensing the residual power stored in said storage cell unit of said solar-power generator, and a pressure sensor unit capable of sensing the pressure in said reservoir of said electric oxyhydrogen generator;
wherein said power controller controls the supply of the electricity from said solar energy collector to said electrodes of said electric oxyhydrogen generator so as to generate the oxyhydrogen gas when the intensity of ambient light sensed by said light sensor unit is sufficient for causing said solar energy collector to generate adequate electricity to enable said electric oxyhydrogen generator to generate the oxyhydrogen gas;
wherein said power controller controls the supply of the electricity from said storage cell unit to said electrodes of said electric oxyhydrogen generator so as to generate the oxyhydrogen gas when the amount of the residual power sensed by said power sensor unit is sufficient for causing said electric oxyhydrogen generator to generate the oxyhydrogen gas; and
wherein said power controller controls the storage of the oxyhydrogen gas in said reservoir when the pressure sensed by said pressure sensor unit is insufficient.
